(19) United States
(12) Patent Application Publication
(10) Pub. No.: US 2026/0176439 A1
(43) Pub. Date: Jun. 25, 2026

(54) EXTREMELY LIGHT FOAM (ELF) MATERIALS WITH TUNABLE MICROSTRUCTURES

(71) Applicant: Triad National Security, LLC, Los Alamos, NM (US)

(72) Inventors: Matthew Douglass Crall, Los Alamos, NM (US); Matthew Nicholson Lee, Los Alamos, NM (US)

(21) Appl. No.: 18/348,705

(22) Filed: Jul. 7, 2023

Related U.S. Application Data
(60) Provisional application No. 63/367,837, filed on Jul. 7, 2022.

(51) Int. Cl. C08J 9/28; C08J 9/00

(52) U.S. Cl. CPC C08J 9/286; C08J 9/0066; C08J 2205/04; C08J 2363/02

(57) ABSTRACT

Described herein are syntactic foams comprising: (i) hollow filler particles; and (ii) an epoxy matrix; wherein, the epoxy matrix is characterized by an ordered microstructure comprising a plurality of vacancies that resides at interstices between the filler particles. The ordered microstructure of the syntactic foams provides the materials with lower densities and higher strengths compared with syntactic foams of the art. Methods of preparing the syntactic foams are additionally described.

### CROSS-REFERENCE TO RELATED APPLICATION(S)

This application claims priority to, and the benefit of, U.S. Provisional Application Ser. No. 63/367,837, filed Jul. 7, 2022, which is hereby incorporated herein by reference in its entirety for all purposes.

### FIELD

The presently disclosed subject matter relates generally to syntactic foam materials having deliberately-tuned microstructures and controlled properties.

### BACKGROUND

Syntactic foams are composite materials whose resinous matrix is embedded with hollow preformed particles such as glass or ceramic microspheres. The voids within the hollow filler particles define a system of pores, and hence the syntactic foam is a specific type of closed-cell foam. Syntactic foams have been used in applications such as undersea/marine equipment for deep-ocean current-metering, anti-submarine warfare, sandwich composites, the aerospace industry, and the automotive industry.

While syntactic foams presently serve many uses, difficulties have been encountered in producing syntactic foams having sufficient high strength and low density. The density of syntactic foams has generally been restricted by the limited porosity of the foams. Porosity is a measure of the total void volume of the syntactic foam, and constitutes the sum of the void volume of the microspheres and the interstitial void volume. The limited porosity of conventional syntactic foams often results in the foams having a disordered microstructure that poses restrictions on its density.

What is needed in the art are straightforward, simple, and reproducible methods for preparing syntactic foams having lighter densities and greater compression strengths. The subject matter described herein addresses this unmet need.

### BRIEF SUMMARY

In one aspect, the presently disclosed subject matter is directed to a syntactic foam comprising: (i) hollow filler particles; and (ii) an epoxy matrix; wherein, the epoxy matrix is characterized by an ordered microstructure comprising a plurality of vacancies that resides at interstices between the filler particles.

In another aspect, the subject matter described herein is directed to a method of preparing a syntactic foam, comprising:
contacting a curing agent with an epoxy to form a first mixture;
contacting the first mixture with a solvent to form a second mixture;
contacting the second mixture with filler particles to form a third mixture;
cooling the third mixture to form a solidified material; and
heating the solidified material to remove the solvent;
wherein, the syntactic foam is prepared.

These and other aspects are described herein.

### BRIEF DESCRIPTION OF THE DRAWINGS

FIG. 1 shows exemplary reagents for preparing ELF materials described herein.

FIG. 2 shows a completed ELF material.

FIG. 3 shows a graph displaying the compressive failure stress versus density data for three different syntactic foam materials, along with microscope images showing the microstructures of the three different foams.

FIG. 4 shows a test specimen of a cylindrical foam material used in the compressive failure stress experiments described herein.

FIG. 5 shows a SEM image of a syntactic foam having a “random separation” microstructure. It is indicative of epoxy precipitating from toluene solution. It phase separates via nucleation and growth, which is distinct from spinodal decomposition. This foam was prepared using less solvent than the foams having a bicontinuous “spinodal” or “nucleation” microstructure described herein. It can be seen that solid epoxy is randomly arranged between the round particles in the material. This syntactic foam exhibits lower strength and is more difficult to process compared with the ELF materials prepared using more solvent according to the methods described herein.

FIGS. 6A and 6B show SEM images of an exemplary ELF material sample prepared in accordance with the methods described herein.

FIGS. 7A and 7B show SEM images of an exemplary ELF material sample prepared in accordance with the methods described herein. The SEM images show a bicontinuous “spinodal” microstructure. The epoxy phase is an open-cell structure that allows the solvent to dry in accordance with the preparative methods disclosed herein. This material structure is light, strong, scalable, and easy to process.

FIG. 8 shows a comparison of bending strength test results for a foam having a nucleation microstructure and a foam having a random separation microstructure.

### DETAILED DESCRIPTION

The subject matter described herein is directed to a syntactic foam comprising filler particles and an epoxy matrix, wherein the epoxy matrix is characterized by an ordered microstructure comprising a plurality of vacancies that resides at interstices between the filler particles. The ordered array of vacancies within the epoxy microstructure of the syntactic foam imparts the material (herein, called an ELF “Extremely Light Foam”) with advantageous properties—including light density and considerable strength.

Syntactic foams are generally known to exhibit good compression/bending strength with low bulk density (i.e. less than water). Conventional syntactic foam materials are often prepared using an epoxy, a curing agent, and a hollow filler. ELF materials, in contrast, are prepared using an epoxy, a curing agent, a solvent that is miscible with the epoxy (i.e., the uncured epoxy monomer), the curing agent (prior to curing), and a filler material. It has been discovered that the use of a solvent as a porogen offers greater control over the pore microstructure. The generation of this exquisite pore morphology within the epoxy matrix of ELF materials renders the final material significantly stronger and lighter than conventional syntactic foams.

The higher strength observed in ELF materials can be attributed to the microstructure of the epoxy phase that resides at the interstitial space between the filler material (i.e. microballoons) in the foam. For a traditional syntactic foam prepared in the absence of solvent, the space between the microballoons is a solid, continuous epoxy phase. While strong, this arrangement limits how low a density can be achieved in the final material. Indeed, the intrinsic density of the epoxy, the filler particles, along with the maximum allowed volume fraction of random close-packed spheres (which is theoretically around 63% for spheres used in syntactic foams) dictate the range of densities that are physically realizable. Surprisingly, the addition of solvent to the reaction mixture during the preparation of the syntactic foam alters the density of the epoxy phase of the final material in advantageous ways. the initial state, the epoxy resin-comprising epoxide-functional monomer and amine-functional monomer-is soluble in the solvent. When the epoxy cures, it eventually becomes immiscible with the solvent and undergoes phase separation. Depending upon the solvent fraction, temperature, and stoichiometric ratio between the two components of the epoxy resin, the phase separation will be one of three types: 1) precipitation of epoxy from a solvent matrix, 2) spinodal decomposition, or 3) precipitation of solvent in an epoxy matrix. The phase separated epoxy-solvent mixture has a complex microstructure between the filler particles. After the solvent evaporates, an empty space remains in the shape that the solvent assumed when it separated from the curing epoxy. Since the solvent acts as a template for the pores, it is referred to as a porogen in this application. Through the selection of solvent type, solvent fraction, and processing conditions (time, temperature, stoichiometric ratio, etc.), it is possible to deliberately tune the arrangement of these empty spaces into a consistent microstructure that is both strong and light. An advantageous arrangement of this empty space can form a material that is twice as strong in compression as a material with an identical epoxy and filler content, but with the empty space distributed in undesirable and random ways. Favorable syntactic foam microstructures can be realized using the processing methods described herein. As further shown herein, the materials having ordered microstructures can achieve strengths at lower densities (<0.4 g/cc) compared to syntactic foams of the art.

Furthermore, ELF material preparation presents several advantages over conventional syntactic foam synthesis. For example, the addition of solvent simplifies processing, as it significantly decreases the viscosity of the material before it cures. This in turn allows for higher loadings of filler into the material, and also simplifies the transfer of the material from the mixing container into a mold. Therefore, ELF can be directly cast into various shapes and sizes. The preparation process is also scalable and economical. For example, the material is formulated with readily available, commercial and non-toxic materials. The final product is non-hazardous, clean, and easy to shape via a variety of methods.

The ELF materials described herein have applications in many industries. For example, the materials'unique combination of compression strength and low density make them an excellent candidate for use in marine submersible vehicle designs, as their physical properties allow the materials to maintain buoyancy at extreme depths without the material compressing and failing. Any flight vehicle could also benefit from this material, as ELF is a strong, low density material that can be easily cast into complex shapes. This makes ELF a good candidate to replace honeycomb infill in composite sandwich panel construction if the geometry is complex enough to make traditional infill techniques difficult. ELF materials are also a great thermal insulator and impact energy absorber. Moreover, these properties, combined with low density, make ELF an excellent candidate for a variety of components in aerospace systems.

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. Unless otherwise defined, all technical and scientific terms used herein have the same meaning as commonly understood by one of ordinary skill in this field. All publications, patent applications, patents, and other references mentioned herein are incorporated by reference in their entirety. In the event that one or more of the incorporated literature, patents, and similar materials differs from or contradicts this application, including but not limited to defined terms, term usage, described techniques, or the like, this application controls.

### I. Definitions

As used herein, “and/or” refers to and encompasses any and all possible combinations of one or more of the associated listed items, as well as the lack of combinations when interpreted in the alternative (“or”).

As used herein, the term “about,” when referring to a measurable value such as an amount of a compound or agent of the current subject matter, dose, time, temperature, and the like, is meant to encompass variations of ±20%, ±10%, ±5%, ±1%, +0.5%, or even ±0.1% of the specified amount.

As used herein, conditional language used herein, such as, among others, “can,” “could,” “might,” “may,” “e.g.,” and the like, unless specifically stated otherwise or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

As used herein, “ELF” stands for “Extremely Light Foam.” As used herein, the term “contacting” refers to allowing two or more reagents to contact each other. The contact may or may not be facilitated by mixing, agitating, stirring, and the like.

As used herein, “room temperature” is about 25° C.

As used herein, the term “gradually” with respect to changing a temperature means a rate of temperature change of <10° C./hour. In certain embodiments, the rate of temperature change is <9, <8, <7, <6, <5, <4, <3, <2, <1, <0.9, <0.8, <0.7, <0.6, <0.5, <0.4, <0.3, <0.2, or <0.1° C./hour.

Additional definitions are provided below.

### II. Syntactic Foams

In certain embodiments, the subject matter described herein is directed to a syntactic foam comprising:
(i) hollow filler particles; and
(ii) an epoxy matrix;
   wherein,
   the epoxy matrix is characterized by an ordered microstructure comprising a plurality of vacancies that resides at interstices between the filler particles.

As used herein, “ordered microstructure comprising a plurality of vacancies” refers to a microstructure that is continuous and contains a series of vacancies arranged in a consistent and uniform (yet non-periodic) manner throughout the foam. As described herein, the presence and arrangement of such vacancies is a result of the processing of the foam that involves application of a solvent.

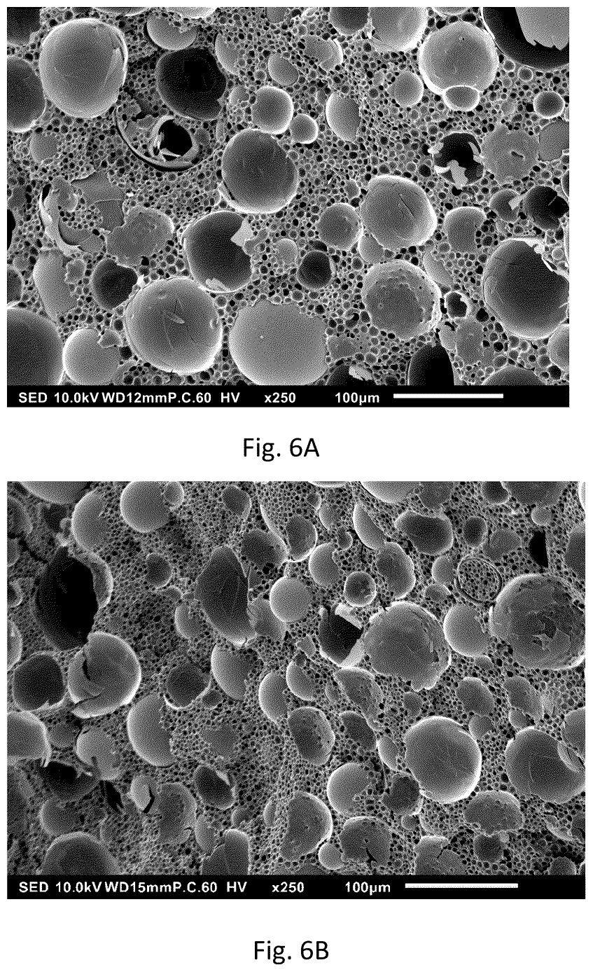

In certain embodiments of the syntactic foam, the ordered microstructure is characterized by a nucleation microstructure. As used herein, “nucleation microstructure” refers to a microstructure in which the interstitial space between filler particles in the foam is filled with epoxy in a regular, closed-cell structure formed by the solvent separating from the epoxy in discrete spheres dispersed throughout (FIGS. 6A and 6B). As used herein, “closed cell structure” refers to a cell totally enclosed by its walls and not interconnecting with any other cells.

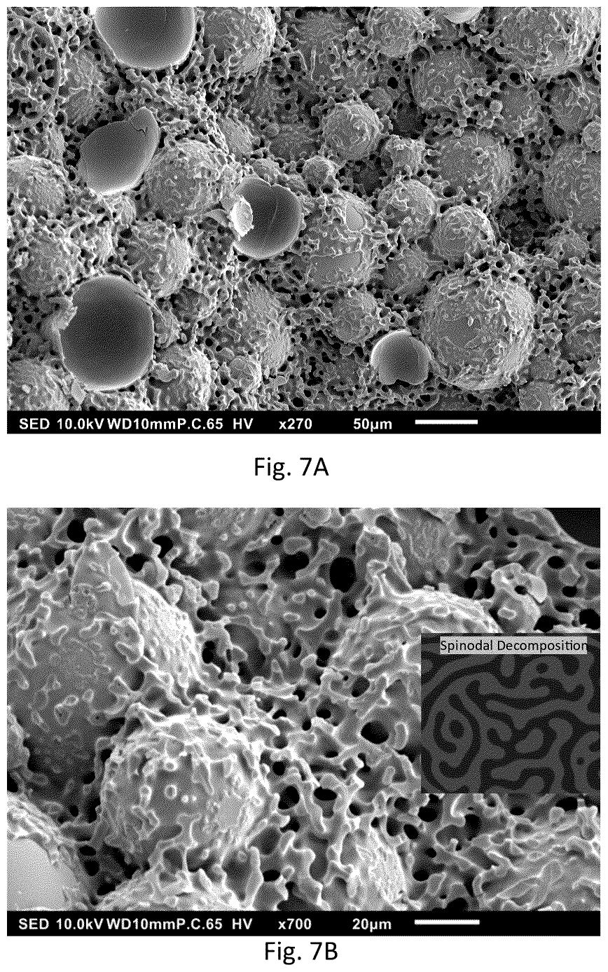

In certain embodiments of the syntactic foam, the ordered microstructure is characterized by a spinodal microstructure. As used herein, “spinodal microstructure” refers to a microstructure in which the epoxy phase is a bicontinuous open-cell structure (FIGS. 7A and 7B). The spinodal microstructure is obtained through spinodal decomposition of the material, by which a single thermodynamic phase spontaneously separates into two phases.

In certain embodiments of the syntactic foam, the syntactic foam has a density of about 0.33 to 0.36 g/cc and a compressive failure stress of about 10 to 12 MPa. In certain embodiments of the syntactic foam, the syntactic foam has a density of about 0.31 to 0.35 g/cc and a compressive failure stress of about 10 to 12 MPa. In certain embodiments, of the syntactic foam, the syntactic foam is characterized by a nucleation microstructure and has a density of about 0.31 g/cc, 0.32 g/cc, 0.33 g/cc, 0.34 g/cc, or 0.35 g/cc and a compressive failure stress of about 10 MPa, 10.1 MPa, 10.2 MPa, 10.3 MPa, 10.4 MPa, 10.5 MPa, 10.6 MPa, 10.7 MPa, 10.8 MPa, 10.9 MPa, 11.0 MPa, 11.1 MPa, 11.2 MPa, 11.3 MPa, 11.4 MPa, 11.5 MPa, 11.6 MPa, 11.7 MPa, 11.8 MPa, 11.9 MPa, or 12 MPa.

In certain embodiments of the syntactic foam, the syntactic foam has a density of about 0.26 to about 0.30 g/cc and a compressive failure stress of about 8-11 MPa. In certain embodiments of the syntactic foam, the syntactic foam has a density of about 0.27 to about 0.29 g/cc and a compressive failure stress of about 8-10 MPa. In certain embodiments, of the syntactic foam, the syntactic foam is characterized by a spinodal microstructure and has a density of about 0.26 g/cc, 0.27 g/cc, 0.28 g/cc, or 0.29 g/cc and a compressive failure stress of about 8.0 MPa, 8.1 MPa, 8.2 MPa, 8.3 MPa, 8.4 MPa, 8.4 MPa, 8.5 MPa, 8.6 MPa, 8.7 MPa, 8.8 MPa, 8.9 MPa, 9.0 MPa, 9.1 MPa, 9.2 MPa, 9.3 MPa, 9.4 MPa, 9.5 MPa, 9.6 MPa, 9.7 MPa, 9.8 MPa, 9.9 MPa, 10.0 MPa, 10.1 MPa, 10.2 MPa, 10.3 MPa, 10.4 MPa, or 10.5 MPa. a syntactic foam, the filler particles are hollow. In certain embodiments, the filler particles are selected from the group consisting of metal, carbon, ceramic, glass, and polymer. In certain embodiments, the filler particles may have an average diameter in the range of from about 0.001 micron (μm) to about 1,000 μm, alternatively from about 5 μm to about 500 μm, alternatively from about 10 μm to about 325 μm, or alternatively from about 5 μm to about 200 μm.

In certain embodiments of the syntactic foam, the filler particles are hollow and comprise carbon microballoons, cenospheres, ceramic microspheres, glass microspheres, polymer microballoons, or combinations thereof. Examples of various microspheres that are commercially available from 3M Company are SCOTCHLITE glass bubbles (hollow spheres) having a crush strength of from about 2,000 to 10,000 psi; iM30K glass bubbles also available from 3M Company having a crush strength of 28,000 psi; Z-LIGHT SPHERES ceramic microspheres having a crush strength of from about 2,000 to 60,000 psi; and ZEEOSPHERES ceramic microspheres having a crush strength of from about 2,000 to 60,000 psi. Examples of other commercially available hollow particles suitable for use in one or more embodiments include, but are not limited to, EXTENDOSPHERES beads commercially available from The PQ Corporation; FILLITE beads commercially available from Trelleberg Fillite, Inc. ; and RECYCLOSPHERE beads and BIONIC BUBBLE beads, both of which are commercially available from Sphere Services, Inc. Still other commercially available hollow particles include the HGS Series glass microspheres commercially available from 3M Company, which range in size from about 80 mesh to about 100 mesh. In certain embodiments, the filler material comprises glass bubbles, such as 3M GLASS BUBBLES K1.

In certain embodiments of the syntactic foam, the epoxy matrix comprises a three-dimensional crosslinked system formed through the reaction of an epoxy selected from the group consisting of bisphenol epoxy resin, aliphatic epoxy resin, novolac epoxy resin, halogenated epoxy resin, epoxy resin diluent, and glycosylamine epoxy resin; and a curing agent selected from the group consisting of polymercaptan curing agent, polyamide curing agent, amidoamine curing agent, amine curing agent, and phenalkamine curing agent. In certain embodiments of the syntactic foam, the epoxy matrix comprises a three-dimensional crosslinked system formed through the reaction of bisphenol A epichlorohy drin liquid epoxy and diethylenetriamine.

### III. Methods of Preparing the Syntactic Foams certain embodiments, the subject matter described herein is directed to a method of preparing a syntactic foam, comprising:

contacting a curing agent with an epoxy to form a first mixture;
contacting the first mixture with a solvent to form a second mixture;
contacting the second mixture with hollow filler particles to form a third mixture;
cooling the third mixture to form a solidified material; and
heating the solidified material to remove the solvent;
wherein, the syntactic foam is prepared.

In certain embodiments of the method of preparing a syntactic foam, the solvent is selected from the group consisting of toluene, hexane, acetone, benzene, cyclohexane, methyl ethyl ketone, ethyl acetate, N, N-dimethylformamide, dimethyl sulfoxide, diethyl ether, tetrahydrofuran, methylene chloride, and carbon tetrachloride, or a combination thereof. In certain embodiments, the solvent is toluene. In certain embodiments, the solvent is any one or more nonpolar, aprotic solvents. In certain other embodiments, the solvent is selected so that it is miscible with the epoxy. In an embodiment, the solvent is miscible with the epoxy and the curing agent.

In certain embodiments, the epoxy is selected from the group consisting of bisphenol epoxy resin, aliphatic epoxy resin, novolac epoxy resin, halogenated epoxy resin, epoxy resin diluent, and glycosylamine epoxy resin. In certain embodiments, the epoxy is selected from the group consisting of thermosetting resins, thermoplastic resins, solid polymer plastics, and combinations thereof. Suitable thermosetting resins may include, but are not limited to, thermosetting epoxies, bismaleimides, cyanates, unsaturated polyesters, noncellular polyurethanes, orthophthalic polyesters, isophthalic polyesters, phthalic/maelic type polyesters, vinyl esters, phenolics, polyimides, including nadic end-capped polyimides (e.g., PMR-15), and combinations thereof. Suitable thermoplastic resins may include, but are not limited to, polyether ether ketones, polyaryletherketones, polysulfones, polyamides, polycarbonates, polyphenylene oxides, polysulfides, including polyphenylenesulfide (PPS), polyether sulfones, polyamide-imides, polyetherimides, polyimides, polyarylates, poly(lactide), poly(glycolide), liquid crystalline polyester, aromatic and aliphatic nylons, and any combinations thereof. In certain embodiments, the epoxy is a thermoset polymer. In one embodiment, the epoxy is bisphenol A epichlorohydrin liquid epoxy (EPON 825). certain embodiments, the curing agent is selected from the group consisting of polymercaptan curing agent, polyamide curing agent, amidoamine curing agent, amine curing agent, and phenalkamine curing agent. Other possible curing agents include, but are not limited to, cyclo-aliphatic amines, aromatic amines, aliphatic amines, imidazole, pyrazole, pyrazine, pyrimidine, pyridazine, 1H-indazole, purine, phthalazine, naphthyridine, quinoxaline, quinazoline, phenazine, imidazolidine, cinnoline, imidazoline, 1,3,5-triazine, thiazole, pteridine, indazole, amines, polyamines, amides, polyamides, 2-ethyl-4-methyl imidazole, and combinations thereof. In certain embodiments, the curing agent is an amine curing agent, such as diethylenetriamine.

In certain embodiments of the method for preparing a syntactic foam, the filler material is selected from the group consisting of metal, carbon, ceramic, glass, and polymer. In certain embodiments, the filler material comprises particles having an average diameter in the range of from about 0.001 micron (μm) to about 1,000 μm, alternatively from about 5 μm to about 500 μm, alternatively from about 10 μm to about 325 μm, alternatively from about 5 μm to about 200 μm.

In certain embodiments of the method of preparing a syntactic foam, the filler material is hollow and comprises carbon microballoons, cenospheres, ceramic microspheres, glass microspheres, polymer microballoons, or combinations thereof. Examples of various microspheres that are commercially available from 3M Company are SCOTCHLITE glass bubbles (hollow spheres) having a crush strength of from about 2,000 to 10,000 psi; iM30K glass bubbles also available from 3M Company having a crush strength of 28,000 psi; Z-LIGHT SPHERES ceramic microspheres having a crush strength of from about 2,000 to 60,000 psi; and ZEEOSPHERES ceramic microspheres having a crush strength of from about 2,000 to 60,000 psi. Examples of other commercially available hollow particles suitable for use in one or more embodiments include, but are not limited to, EXTENDOSPHERES beads commercially available from The PQ Corporation; FILLITE beads commercially available from Trelleberg Fillite, Inc. ; and RECYCLOSPHERE beads and BIONIC BUBBLE beads, both of which are commercially available from Sphere Services, Inc. Still other commercially available hollow particles include the HGS Series glass microspheres commercially available from 3M Company, which range in size from about 80 mesh to about 100 mesh. In certain embodiments, the filler material comprises glass bubbles, such as 3M GLASS BUBBLES K1.

In certain embodiments of the method of preparing a syntactic foam, contacting the curing agent with the epoxy to form a first mixture proceeds at room temperature. In certain embodiments, the contacting proceeds until a homogeneous mixture (first mixture) is obtained.

In certain embodiments of the method of preparing a syntactic foam, contacting the first mixture with a solvent to form a second mixture proceeds until a homogeneous mixture (second mixture) is obtained.

In certain embodiments of the method of preparing a syntactic foam, contacting the second mixture with filler particles proceeds until a homogeneous mixture (third mixture) is obtained.

In certain embodiments of the method of preparing a syntactic foam, the method further comprises placing the third mixture into a mold prior to cooling the third mixture. Following cooling, the solidified material is removed from the mold.

In certain embodiments of the method of preparing a syntactic foam, cooling the third mixture to form a solidified material proceeds at a temperature of about 5 to about 25° C., about 7° C. to 15° C., about 10° C. to 12° C., about 5° C. to 10° C., or about 8° C. to 13° C.

In certain embodiments of the method of preparing a syntactic foam, cooling the third mixture to form a solidified material proceeds for about 5 to 10 days. In certain embodiments of the method of preparing a syntactic foam, cooling the third mixture to form a solidified material proceeds for about 5, 6, 7, 8, 9, or 10 days. The cooling proceeds until the third mixture solidifies, thereby setting the microstructure.

In certain embodiments of the method of preparing a syntactic foam, following cooling the third mixture to form a solidified material, the solidified material is allowed to sit at room temperature for about 2 hours to about 100 hours. In certain embodiments, the solidified material sits for about 24 hours to 72 hours.

In certain embodiments of the method of preparing a syntactic foam, heating the solidified material to remove the solvent comprises heating the solidified material at a temperature of about 35° C. under an inert atmosphere, followed by gradually raising the temperature to about 110° C. to cure the solidified material. In certain embodiments, the inert atmosphere is flowing nitrogen gas.

In certain embodiments of the method of preparing a syntactic foam, heating the solidified material to remove the solvent proceeds for about 1, 2, 3, 4, 5, 6, 7, 8, 9, 10, 11, or 12 weeks at a temperature of about 35° C. under an inert atmosphere. The time required for heating to dry out the solvent depends on the size of the part. Once the material appears dry, the solidified material is heated at a pace of about 5° C./day to a temperature of about 110° C. to cure the solidified material.

In certain embodiments of the method of preparing a syntactic foam, the temperature is maintained at 110° C. for about 5 to 10 days. In certain embodiments, the temperature is maintained for about 5, 6, 7, 8, 9, or 10 days.

In certain embodiments of the method of preparing a syntactic foam, following heating the solidified material to remove the solvent, the heat is turned off and the solidified material gradually cools to room temperature to form the syntactic foam.

In certain embodiments, the epoxy and curing agent begin to polymerize and phase separate from the solvent while they still form a liquid mixture, but before polymerization proceeds to the point where the epoxy polymer becomes a solid. In certain embodiments, the phase separated epoxy continues to polymerize until it becomes a solid that is mixed with a liquid solvent in a well-defined microstructure.

In certain embodiments, the curing agent, epoxy, solvent, and filler material are present in a molar ratio of about 2.7 to 4.7:9.8 to 10.8:38 to 50:13 to 23. In certain embodiments, the curing agent, epoxy, solvent, and filler material are present in a molar ratio of about 3.3:10.3:43.4:18.3, wherein the before-mentioned molar ratios are for preparing an ELF material having a bicontinuous spinodal microstructure, for example. In certain other embodiments, the curing agent, epoxy, solvent, and filler material are present in a molar ratio of about 4.2:10.3:43.4:18.3, wherein the before-mentioned molar ratios for preparing an ELF material having a nucleation microstructure, for example. In certain other embodiments, the curing agent is present in a molar ratio of about 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, or 4.7; the epoxy is present in a molar ratio of about 9.8, 9.9, 10.0, 10.1, 10.2, 10.3, 10.4, 10.5, 10.6, 10.7, or 10.8; the solvent is present in a molar ratio of about 38, 39, 40, 41, 42.0, 42.1, 42.2, 42.3, 42.4, 42.5, 42.6, 42.7, 42.8, 42.9, 43.0, 43.1, 43.2, 43.3, 43.4, 43.5, 43.6, 43.7, 43.8, 43.9, 44.0, 44.1, 44.2, 44.3, 44.4, 44.5, 44.6, 44.7, 44.8, 44.9, 45, 46, 47, 48, 49, or 50; and the filler material is present in a molar ratio of about 13, 14, 15, 16, 17.0, 17.1, 17.2, 17.3, 17.4, 17.5, 17.6, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20, 21, 22, or 23.

The same molar ratios apply to the ELF material itself, except that the solvent is absent. In other words, certain embodiments, the curing agent, epoxy, and filler material are present in a molar ratio of about 2.7 to 4.7:9.8 to 10.8:13 to 23. In certain embodiments, the curing agent, epoxy, and filler material are present in a molar ratio of about 3.3:10.3:18.3, wherein the before-mentioned molar ratios are in an ELF material having a bicontinuous spinodal microstructure, for example. In certain other embodiments, the curing agent, epoxy, and filler material are present in a molar ratio of about 4.2:10.3:18.3, wherein the before-mentioned molar ratios are in an ELF material having a nucleation microstructure, for example. In certain other embodiments, the curing agent is present in a molar ratio of about 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, or 4.7; the epoxy is present in a molar ratio of about 9.8, 9.9, 10.0, 10.1, 10.2, 10.3, 10.4, 10.5, 10.6, 10.7, or 10.8; and the filler material is present in a molar ratio of about 13, 14, 15, 16, 17.0, 17.1, 17.2, 17.3, 17.4, 17.5, 17.6, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20, 21, 22, or 23.

The following examples are offered by way of illustration and not by way of limitation.

### EXAMPLES

Example 1

### Preparation of ELF Material Having Spinodal Microstructure

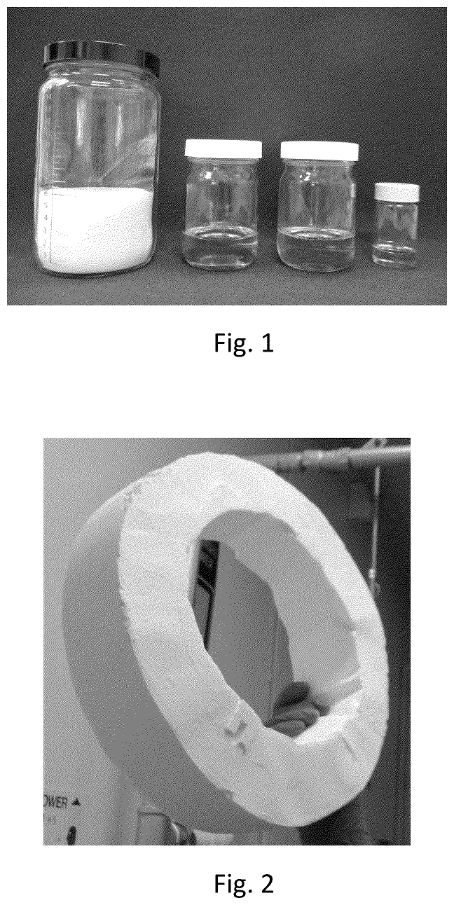

Exemplary reagents for preparing ELF materials are provided in FIG. 1. The following procedure is for preparing an ELF material having a bicontinuous spinodal microstructure (FIGS. 7A and 7B). FIG. 7B includes an inset of a diagram of spinodal decomposition. Approximately 3.42 grams of diethylenetriamine (curing agent) was measured and added to 36 grams of EPON 825 (epoxy resin) at room temperature. The curing agent-epoxy mixture was mixed at room temperature until the mixture became homogeneous. Following this, 40 g of toluene was added to the mixture and mixed until the mixture became homogeneous. After addition of the toluene, 11 g of glass bubbles (3M K1) was added to the mixture and mixed until the mixture became homogeneous. The mixture was then poured into a mold. The filled mold was then placed into a temperature-controlled chamber at a temperature between 7° C. and 15° C. The filled mold remained in the chamber for about one week, until the material in the mold became solid, at which point the microstructure was set. The mold was then removed from the temperature-controlled chamber and the material was removed from the mold. The material was allowed to remain at room temperature for about 24 to 72 hours. The material was then placed in an oven under nitrogen flow at 35° C. for several weeks (i.e. two to eight weeks) to dry out the solvent. the material was dried of all solvent, the oven temperature was ramped up at a rate of 5° C./day until the temperature reached 110° C. The material remained at 110° C. in the oven for one week. After a week, the oven was turned off and the material was allowed to cool gradually to room temperature to form a completed ELF material (FIG. 2).

### Example 2

### Preparation of Elf Material Having Nucleation Microstructure

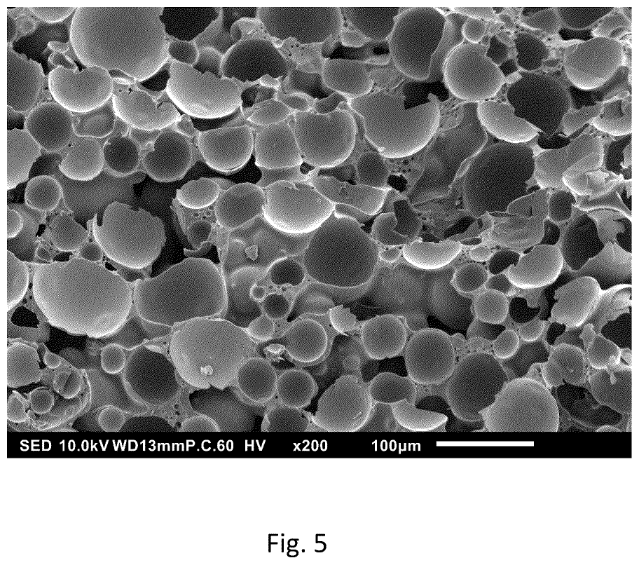

Exemplary reagents for preparing ELF materials are provided in FIG. 1. The following procedure is for preparing an ELF material having a nucleation microstructure (FIGS. 6A and 6B). The SEM images show a “nucleation” microstructure, in which the interstitial space between the particles in the images is filled with epoxy in a regular, closed-cell structure. The material in these figures contains the same amount of epoxy and particles as the material in FIG. 5, but is twice as strong due to the smaller size of the pores within the epoxy and their uniform size distribution. Unfortunately, this microstructure offers no pathway for the solvent to escape. The toluene must diffuse through the epoxy polymer in order to evaporate. While the strength-to-weight ration is better than the “random separation” morphology, it is still not as good as for the “spinodal” microstructure.

To form the material shown in FIGS. 6A and 6B, approximately 4.2 grams of diethylenetriamine (curing agent) was measured and added to 36 grams of EPON 825 (epoxy resin) at room temperature. The curing agent-epoxy mixture was mixed at room temperature until the mixture became homogeneous. Following this, 40 g of toluene was added to the mixture and mixed until the mixture became homogeneous. After addition of the toluene, 11 g of glass bubbles (3M K1) was added to the mixture and mixed until the mixture became homogeneous. The mixture was then poured into a mold. The filled mold was then placed into a temperature-controlled chamber at room temperature. The filled mold remained in the chamber at room temperature for about one week, until the material in the mold became solid, at which point the microstructure was set. The mold was then removed from the temperature-controlled chamber and the material was removed from the mold. The material was allowed to remain at room temperature for about 24 to 72 hours. The material was then placed in an oven under nitrogen flow at 35° C. for several weeks (i.e. two to eight weeks) to dry out the solvent. When the material was dried of all solvent, the oven temperature was ramped up at a rate of 5° C./day until the temperature reached 110° C. The material remained at 110° C. in the oven for one week. After a week, the oven was turned and the material was allowed to cool gradually to room temperature to form a completed ELF material (FIG. 2).

### Example 3

### Preparation of Elf Material Having Random Microstructure

Exemplary reagents for preparing ELF materials are provided in FIG. 1. The following procedure is for preparing an ELF material having a random microstructure (FIG. 5). Approximately 4.2 grams of diethylenetriamine (curing agent) was measured and added to 36 grams of EPON 825 (epoxy resin) at room temperature. The curing agent-epoxy mixture was mixed at room temperature until the mixture became homogeneous. Following this, 30 g of toluene was added to the mixture and mixed until the mixture became homogeneous. After addition of the toluene, 11 g of glass bubbles (3M K1) was added to the mixture and mixed until the mixture became homogeneous. The mixture was then poured into a mold. The filled mold was then placed into a temperature-controlled chamber at room temperature. The filled mold remained in the chamber at room temperature for about one week, until the material in the mold became solid, at which point the microstructure was set. The mold was then removed from the temperature-controlled chamber and the material was removed from the mold. The material was allowed to remain at room temperature for about 24 to 72 hours. The material was then placed in an oven under nitrogen flow at 35° C. for several weeks (i.e. two to eight weeks) to dry out the solvent. When the material was dried of all solvent, the oven temperature was ramped up at a rate of 5° C./day until the temperature reached 110° C. The material remained at 110° C. in the oven for one week. After a week, the oven was turned off and the material was allowed to cool gradually to room temperature to form a completed ELF material (FIG. 2).

### Example 4

### Compressive Failure-Density Experiments

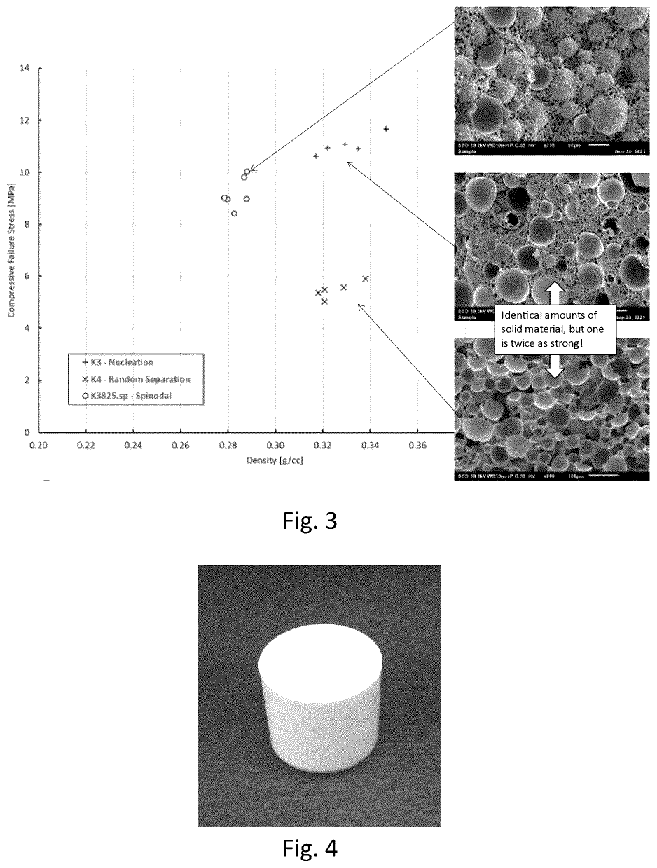

Provided in FIG. 3 is a graph showing the compressive failure versus density data obtained for three different syntactic foam formulations. Three different syntactic foams were evaluated. The first (random separation) is a foam prepared in accordance with the methods described herein (Example 3) using 30 g solvent. The second (nucleation) was prepared using 40 g solvent in accordance with the methods described herein (i.e. Example 2). The third (spinodal) was prepared using 40 g solvent in accordance with the methods described herein (i.e. Example 1).

To the right of the graph in FIG. 3 are microscope images showing the microstructures of the three different foams. The bottom image displays a “random separation” microstructure that forms when epoxy precipitates from the solvent. It forms a continuous epoxy phase that coats the hollow glass microspheres. Because of the large void space in the epoxy, it is relatively weak for its density. The middle image displays a “nucleation” microstructure that is formed by the precipitation of solvent droplets within the epoxy matrix. Though having similar density as the bottom image, it has nearly double the strength. Unfortunately, the trapped solvent within those closed cell voids is difficult to remove. The top image displays the desired “spinodal” epoxy microstructure. This bicontinuous pore network has a remarkably uniform size distribution. It contains no narrow necks, sharp edges, or abnormally large pores that would serve as nucleation sites for catastrophic failure. It therefore has both high strength and low density (up and to the left on this curve are best).

The tests were performed on cylinders of the material that were weighed and measured to calculate their density (FIG. 4). The ELF material was molded in cups sized larger than the desired test cylinders. The test cylinders (r=0.56″, h=1″) were cut out of the larger pieces once the material had cured. Each cylinder was then crushed in a mechanical testing machine (MTS Criterion mechanical tester) until the material failed. The load at failure was defined as the highest load achieved prior to the first load drop during a compression test. This test produced a compressive stress value at failure, which was plotted against the measured density value in FIG. 3.

As can be seen in FIG. 3, the foam characterized by a nucleation microstructure contains the same amount of solid material as that of the random separation foam, but is two times as strong. This difference in strength is at least a result of the variation in the amount of solvent used in preparing the foams (i.e. the nucleation foam preparation involved the presence of more solvent). The foam characterized as having a bicontinuous spinodal microstructure, which was also prepared using more solvent than that of the random separation foam, fared well in the compressive failure-density experiments, achieving high compressive strengths at low densities.

### Example 5

### Bending Stress Experiments

As a counterpart to the compressive failure test, a bending stress at failure test was also performed according to ASTM D790. One composition tested was K3, an ELF material having a nucleation microstructure, as prepared in Experiment 2. It contained 11 g of glass microballoons, 40 g of toluene, 36 g of EPON 825, and 4.3 g of diethylene triamine. Also tested was KCF3, which had a random separation microstructure. This formulation included 11 g of glass microballoons, 40 g of toluene, 30 g of EPON 825, and 3.6 g of diethylenetriamine.

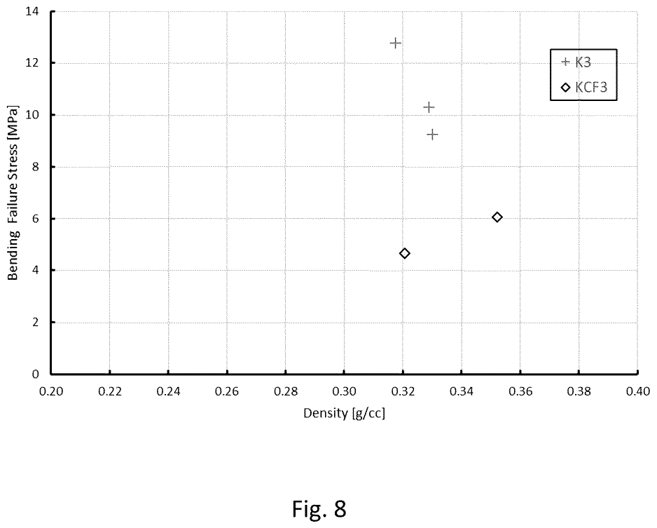

As can be seen in FIG. 8, K3 outperformed KCF3 despite having comparable densities. K3 had a “nucleation” microstructure, while KCF3 had a “random separation” microstructure. Much like with compression strength measurements, the “nucleation” microstructure of the epoxy is stronger than the “random separation” microstructure for the same density.

Unless defined otherwise, technical and scientific terms used herein have the same meaning as commonly understood by one of ordinary skill in the art to which this subject matter belongs.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller ranges is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A syntactic foam comprising:
(i) hollow filler particles; and
(ii) an epoxy matrix;
wherein,
the epoxy matrix comprises an ordered microstructure comprising a plurality of vacancies that resides at interstices between the filler particles.

2. The syntactic foam of claim 1, wherein the ordered microstructure is characterized by a nucleation microstructure.

3. The syntactic foam of claim 1, wherein the ordered microstructure is characterized by a spinodal microstructure.

4. The syntactic foam of claim 1, wherein the foam has a density of about 0.33 to 0.36 g/cc and a compressive failure stress of about 10 to 12 MPa.

5. The syntactic foam of claim 1, wherein the foam has a density of about 0.26 to about 0.30 g/cc and a compressive failure stress of about 8-11 MPa.

6. A method of preparing the syntactic foam of claim 1, comprising:
contacting a curing agent with an epoxy to form a first mixture;
contacting the first mixture with a solvent to form a second mixture;
contacting the second mixture with hollow filler particles to form a third mixture;
cooling the third mixture to form a solidified material; and
heating the solidified material to remove the solvent;
wherein, the syntactic foam is prepared.

7. The method of claim 6, wherein the solvent is selected from the group consisting of toluene, hexane, acetone, benzene, cyclohexane, methyl ethyl ketone, ethyl acetate, N, N-dimethylformamide, dimethyl sulfoxide, diethyl ether, tetrahydrofuran, methylene chloride, and carbon tetrachloride, or a combination thereof.

8. The method of claim 7, wherein the solvent is toluene.

9. The method of claim 6, wherein the epoxy is selected from the group consisting of bisphenol epoxy resin, aliphatic epoxy resin, novolac epoxy resin, halogenated epoxy resin, epoxy resin diluent, and glycosylamine epoxy resin.

10. The method of claim 9, wherein the epoxy is bisphenol A epichlorohydrin liquid epoxy.

11. The method of claim 6, wherein the solvent is miscible with the epoxy and the curing agent.

12. The method of claim 6, wherein the curing agent is selected from the group consisting of polymercaptan curing agent, polyamide curing agent, amidoamine curing agent, amine curing agent, and phenalkamine curing agent.

13. The method of claim 12, wherein the curing agent is an amine curing agent.

14. The method of claim 6, wherein the hollow filler particles are selected from the group consisting of metal, carbon, ceramic, glass, and polymer particles.

15. The method of claim 14, wherein the hollow filler particles comprise hollow glass bubbles.

16. The method of claim 6, wherein the curing agent, epoxy, solvent, and hollow filler particles are present in a molar ratio of about 2.7 to 4.7:9.8 to 10.8:38 to 50:13 to 23.

17. The method of claim 6, wherein cooling the third mixture proceeds at a temperature from about 5 to about 25° C.

18. The method of claim 6, wherein the epoxy and curing agent begin to polymerize and phase separate from the solvent while they still form a liquid mixture, but before polymerization proceeds to the point where the epoxy polymer becomes a solid.

19. The method of claim 6, wherein the phase separated epoxy continues to polymerize until it becomes a solid that is mixed with a liquid solvent in a well-defined microstructure.

20. The method of claim 6, wherein heating the solidified material to remove the solvent comprises heating the solidified material at a temperature of about 35° C. under an inert atmosphere, followed by gradually raising the temperature to about 110° C. to cure the solidified material.
